(19) United States
(12) Patent Application Publication
(10) Pub. No.: US 2026/0203374 A1
(43) Pub. Date: Jul. 16, 2026

(54) METHOD AND SYSTEM FOR DETERMINING EXPLAINABLE DOMAIN GAP METRIC

(71) Applicant: Panasonic Intellectual Property Management Co., Ltd., Osaka (JP)

(72) Inventors: MUHAMMAD USMAN, Singapore (SG); TENTA KOMATSU, Osaka (JP); ARIEL BECK, Singapore (SG)

(21) Appl. No.: 19/021,441

(22) Filed: Jan. 15, 2025

(51) Int. Cl. G06F 17/18; G06F 5/01

(52) U.S. Cl. CPC G06F 17/18; G06F 5/01

(57) ABSTRACT

The present disclosure relates to a method for determining one or more domain gap metrics for time series data. The method includes obtaining a first time series data set and a second time series data set. The method includes determining a first set of features, associated with the first time series data set, with respect to a plurality of perspectives. The method includes determining a second set of features, associated with the second time series data set, with respect to the plurality of perspectives. The method includes determining a plurality of divergence values associated with a distribution of the first set of features and the second set of features, across the plurality of perspectives using a predetermined divergence metric. The method includes determining the one or more domain gap metrics by combining the plurality of divergence values in a predetermined manner.

### FIELD OF THE INVENTION

The present disclosure relates generally to machine learning, and more specifically, to a method and a system for generating explainable domain gap metrics for fine-tuning a machine learning model.

### BACKGROUND

In the field of machine learning, particularly in transfer learning, a significant technical challenge arises when trying to determine the domain similarity or difference between datasets. Transfer learning involves taking a machine learning model trained on one domain i.e., the source domain and applying it to a different but related domain i.e., the target domain. However, the effectiveness of this approach depends heavily on the similarities or differences between the source and target domains. The existing techniques to measure differences between the source and target domains either rely on deep learning techniques that provide minimal explainability or are tied to the machine learning model training process itself. Consequently, this creates a gap in understanding the nature of the differences between the source and target domains, particularly in terms of quantifiable and interpretable features. Thus, without such insights, machine learning practitioners must often rely on expensive, time-consuming experiments to determine whether transfer learning is viable, which is inefficient and resource-intensive.

In a technical problem prevalent in the existing techniques, there is no widely adopted technique to measure domain differences in a way that is explainable and may provide actionable insights into the underlying features contributing to the gap between domains. Deep learning-based techniques may offer high accuracy, but they lack transparency, leaving practitioners without a clear understanding of why the machine learning model fails or succeeds in the target domain. Further, most techniques are integrated within the model training process, which means they are useful only after considerable training has been completed. Consequently, this delays any insight into whether data of the source domain is appropriate for transfer learning and makes it difficult to fine-tune the machine learning models efficiently before committing significant resources to the process.

Therefore, there is a need for a solution to address the aforementioned issues and challenges.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for determining one or more domain gap metrics for time series data is disclosed. The method includes obtaining a first time series data set and a second time series data set. Further, the method includes determining a first set of features, associated with the first time series data set, with respect to a plurality of perspectives. Furthermore, the method includes determining a second set of features, associated with the second time series data set, with respect to the plurality of perspectives. Furthermore, the method includes determining a plurality of divergence values associated with a distribution of the first set of features and the second set of features, between the first time series data and the second time series data across the plurality of perspectives using a predetermined divergence metric. Furthermore, the method includes determining the one or more domain gap metrics by combining the plurality of divergence values in a predetermined manner.

According to an embodiment of the present disclosure, a system for determining one or more domain gap metrics for time series data is disclosed. The system includes a memory and a processor associated with the memory. The processor is configured to obtain a first time series data set and a second time series data set. Further, the processor is configured to determine a first set of features, associated with the first time series data set, with respect to a plurality of perspectives and a second set of features, associated with the second time series data set, with respect to the plurality of perspectives. Furthermore, the processor is configured to determine a plurality of divergence values associated with a distribution of the first set of features and the second set of features, between the first time series data and the second time series data across the plurality of perspectives using a predetermined divergence metric. Furthermore, the processor is configured to determine the one or more domain gap metrics by combining the plurality of divergence values in a predetermined manner.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment comprising a system for determining one or more domain gap metrics, according to an embodiment of the present disclosure;

FIG. 2 illustrates a schematic block diagram of modules of the system for determining the one or more domain gap metrics, according to an embodiment of the present invention;

FIG. 3 illustrates an exemplary process flow of the system for determining the one or more domain gap metrics, according to an embodiment of the present invention;

FIG. 4 illustrates an exemplary representation of frequency spectrum for the one or more domain gap metrics generated by the system, according to an embodiment of the present invention; and

FIG. 5 illustrates a flowchart depicting a method for determining the one or more domain gap metrics using the system, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure addresses the technical problem of determining the domain similarity or difference between datasets in transfer learning. In the present disclosure, explainable domain gap metrics provide detailed, interpretable insights into statistical features extracted from time series data across multiple perspectives, for instance, time domain, frequency domain, and graph domain. Thus, based on determining the divergence between the statistical features in a quantifiable manner, the present disclosure enables practitioners to understand the specific nature of the domain differences. Advantageously, this allows for better data preprocessing, augmentation, and model optimization before a machine learning model training phase begins. Moreover, the explainable domain gap metrics may be applied to various use cases, such as artificial intelligence (AI) model fine-tuning, optimal data selection, and simulator optimization, offering flexibility and cost-effectiveness by reducing the need for costly experimentation.

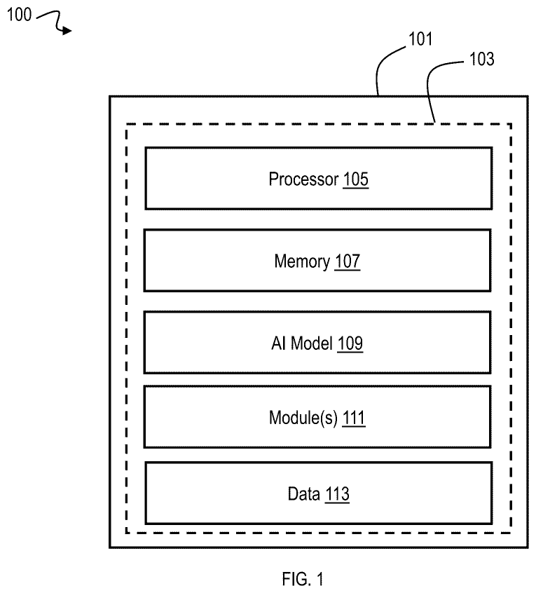

FIG. 1 illustrates an environment comprising a system 101 for determining one or more domain gap metrics, according to an embodiment of the present disclosure.

The system 101 may include, but is not limited to, at least one processor 105 (alternatively referred to as processor), memory 107, at least one AI model 109, modules 111, and data 113. The modules 111 and the memory 107 may be communicably coupled to the processor 105.

The processor 105 can be a single processing unit or several units, all of which could include multiple computing units. The processor 105 may be implemented as one or more microprocessors, microcomputers, microcontrollers, digital signal processors, central processing units, state machines, logic circuitries, and/or any devices that manipulate signals based on operational instructions. Among other capabilities, the processor 105 is adapted to fetch and execute computer-readable instructions and data stored in the memory 107.

The memory 107 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 111, amongst other things, include routines, programs, objects, components, data structures, etc., which perform particular tasks or implement data types. The modules 111 may also be implemented as, signal processor(s), state machine(s), logic circuitries, and/or any other device or component that manipulates signals based on operational instructions.

Further, the modules 111 can be implemented in hardware, instructions executed by a processing unit, or by a combination thereof. The processing unit can comprise a computer, a processor, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 111 may be machine-readable instructions (software) which, when executed by a processor/processing unit, perform any of the described functionalities.

Further, the system 101 may be integrated within a server, a personal computing device, a user equipment, a laptop, a tablet, a mobile communication device, and so forth.

In an embodiment, the system 101 may correspond to a stand-alone system provided on an electronic device. The electronic device may include a personal computing device, a user equipment, a laptop, a tablet, a mobile communication device, or any other device capable of hosting processing and memory units. In an embodiment, the one or more domain gap metrics may be generated on an output device (not shown) communicatively coupled to the system 101 or may be integrated with the electronic device hosting the system 101. In an alternate embodiment, the output device may be a separate device from the electronic device hosting the system 101.

In another embodiment, the system 101 may be based on a server/cloud architecture and the system 101 may be communicably coupled to the output device via a network (not shown). The network may be a communication network, a wireless network, a wired network, and the like. In another embodiment, the system 101 may be provided in a distributed manner, in that, one or more components of the system 101 may be provided, one or more components and/or functionalities of the system 101 are provided through an electronic device, and one or more components and/or functionalities of the system 101 are provided through a cloud-based unit, such as a cloud storage or a cloud-based server.

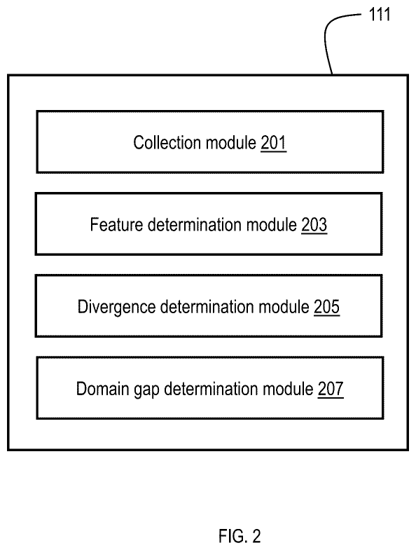

FIG. 2 illustrates a schematic block diagram of modules 111 of the system 101 for determining the one or more domain gap metrics, according to an embodiment of the present invention.

In an embodiment, the modules 111 may include a collection module 201, a feature determination module 203, a divergence determination module 205 and a domain gap determination module 207. The collection module 201, the feature determination module 203, the divergence determination module 205 and the domain gap determination module 207 may be in communication with each other. The data 113 serves, amongst other things, as a repository for storing data processed, received, and generated by one or more of the modules 111.

Referring to FIG. 1 and FIG. 2 the collection module 201 may be configured to obtain a first time series data set and a second time series data set. Further, the feature determination module 203 may be configured to determine a first set of features, associated with the first time series data set, with respect to a plurality of perspectives. Furthermore, the feature determination module 203 may be configured to determine a second set of features, associated with the second time series data set, with respect to the plurality of perspectives.

The divergence determination module 205 may be configured to determine a plurality of divergence values associated with a distribution of the first set of features and the second set of features. The plurality of divergence values may be distributed between the first time series data and the second time series data across the plurality of perspectives using a predetermined divergence metric.

The domain gap determination module 207 may be configured to determine the one or more domain gap metrics by combining the plurality of divergence values in a predetermined manner.

For the sake of brevity, the architecture, and standard operations of the memory 107 and the processor 105 are not discussed in detail. In one embodiment, the memory 107 may be configured to store the information, such as the first time series data set and the second time series data set as required by the processor 107 to perform the methods described herein. A detailed description of the module 111 is provided in the further paragraphs.

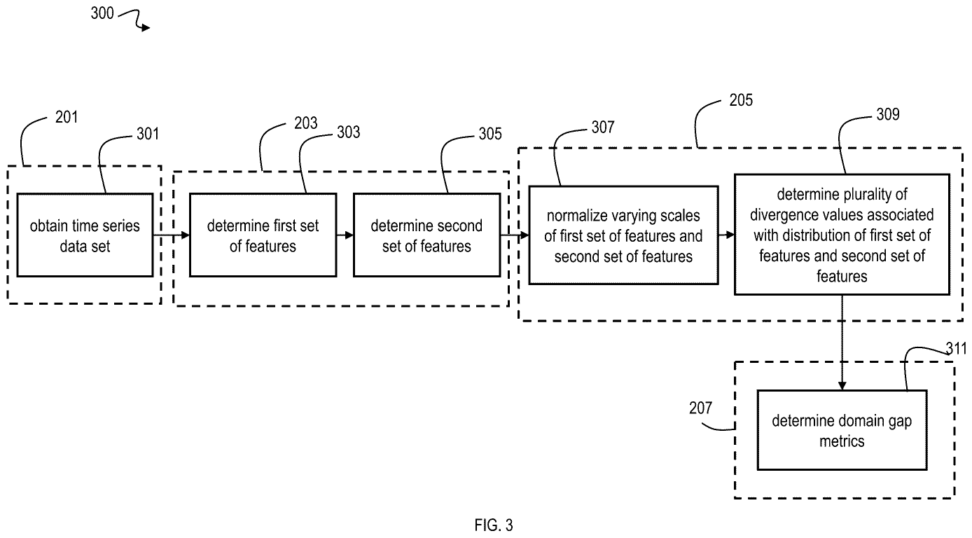

FIG. 3 illustrates an exemplary process flow of the system 101 for determining the one or more domain gap metrics, according to an embodiment of the present invention.

At operation 301, the collection module 201 may be configured to obtain the first time series data set and the second time series data set.

In an embodiment, the first time series data set is generated from a source dataset or a source domain, and the second time series data set is derived from a target dataset. These datasets represent two distinct sets of time series data that the system 101 intends to analyze and compare for the purpose of measuring domain similarity or domain difference, which is crucial for applications like transfer learning, data selection, or model optimization.

In an embodiment, the source dataset may correspond to data that has already been collected, processed, or modelled. In a non-limiting example, the source dataset may represent synthetic data generated by an AI model or simulator, historical data previously collected in past experiments or scenarios and known datasets that have been used in prior model training or simulations.

In an embodiment, the target dataset may correspond to real-time data being collected in a live environment, for instance, data from sensors, market transactions, or user behaviour. In a non-limiting example, the target dataset may represent new data from a related but distinct environment where the AI model 109 is expected to be applied, however, the conditions may differ from the source domain.

In an embodiment, during transfer learning, the system 101 may be configured to obtain knowledge from the source domain i.e., the first time series data set to the target domain i.e., the second time series data set. In an advantageous aspect, measuring the difference or similarity between the first time series dataset and the second time series dataset helps in fine-tuning the AI model 109 and ensuring effective adaptation.

Accordingly, the collection module 201 is configured to ensure that the first time series dataset and the second time series dataset are accurately obtained, pre-processed, and prepared for subsequent analysis.

In an example embodiment, the collection module 201 is configured to obtain the first time series dataset and the second time series dataset from different sources. In a non-limiting example, the sources may include, data storage systems or databases such as historical or synthetic data, real-time data streams such as sensors or online systems.

The collection module 201 is configured to ensure that the datasets are in the right format and synchronized. In time series data, the synchronization is particularly important because the system 101 must accurately align time steps between the two datasets (i.e., the first time series dataset and the second time series dataset). Any mismatch in time frames, data granularity, or frequency may lead to incorrect domain gap measurements, resulting in poor insights into the similarity or divergence between the datasets.

In an example embodiment, once the first time series dataset and the second time series dataset have been obtained, the collection module 201 is configured to ensure that they are ready for the next steps. Thus, the system 101 has two well-defined data sets i.e., one representing the source domain and the other representing the target domain. Advantageously, both datasets are critical for measuring the statistical differences between the domains and informing decisions about the AI model 109 adjustments, data selection, or system optimizations.

At operation 303, the feature determination module 203 may be configured to determine the first set of features, associated with the first time series data set, with respect to a plurality of perspectives. Further, the plurality of perspectives corresponds to a plurality of statistical indices.

In an embodiment, the first set of features corresponds to extracting key statistical and structural properties from the time series data that are later compared with the second time series data set (or associated features).

Accordingly, the first set of features corresponds to various statistical properties or descriptors of the first time series data set. Thus, the first time series data set data is broken down into meaningful features that may represent underlying patterns and characteristics of the first time series data set. In an advantageous aspect, the richness and variety of the first set of features directly affect the accuracy and depth of the subsequent domain gap analysis.

In an embodiment, the plurality of perspectives refers to multiple statistical indices capturing different aspects of the data's behaviour and characteristics. Furthermore, the plurality of statistical indices includes one or more of, time domain indices, frequency domain indices, non-linear domain indices, time-frequency domain indices, shape domain indices, and graph domain indices.

Further, perspectives refer to different ways in which the first time series data set may be analysed using different statistical indices. The plurality of statistical indices represents different domains and mathematical approaches that extract specific types of information from the first time series data set. Since the first time series data set may vary significantly across different dimensions for instance, time, frequency, or shape Thus, it may be advantageous to analyse the first time series data set from these diverse perspectives to ensure a thorough comparison between the two datasets.

In an example embodiment, the plurality of statistical indices mentioned includes, but is not limited to time domain indices. The time domain indices analyse the first time series data set in the time domain, consequently, focusing on the evolution of the first time series data set over time. The time domain indices may include, but is not limited to Mean, variance, and skewness thus, representing the basic statistical properties of the data values across time. Further, time domain indices may include an autocorrelation for measuring influence on the current data points by previous data points. Consequently, the autocorrelation reflects the memory or lag effect in the first time series data set. Further, time domain indices may include a trend and seasonality for capturing long-term upward or downward movements and recurring patterns in the first time series data set. Further, Table 1 below depicts an exemplary non-exhaustive list of plurality of statistical indices.

TABLE 1

| Time | Frequency | Non-Linear | Time-Frequency | Shape | Graph |
|---|---|---|---|---|---|
| Mean, Mode, | Total | Shannon | Maximum, | Shape Factor | Transitivity |
| Median | power | Entropy | Minimum, Mean | | |
| | | | and Sum of values | | |
| | | | of Spectrogram in | | |
| | | | Various Time | | |
| | | | Intervals | | |
| Standard | Power of | Multiscale | Difference between | Impulse Factor | Mean and |
| Deviation of | Various | Entropy | Maximum and | | Standard |
| Original and | Frequency | | Minimum of values | | Deviation of |
| Discrete | Bands | | of Spectrogram in | | Cluster |
| Difference of | | | Various Time | | Coefficients |
| time series | | | Intervals | | |
| Ratio of | Ratios of | Petrosian | Ratio of Standard | Crest Factor | Assortativity |
| Standard | Power | and Higushi | Deviation and Mean | | Coefficient |
| Deviation and | amongst | Fractal | of values of | | |
| Mean | Various | | Spectrogram in | | |
| | Frequency | | Various Time | | |
| | Bands | | Intervals | | |
| Skewness of | Ratio of | Spectral | Total Power of | Clearance | Mean and |
| Original and | Power in a | Entropy of | Various Frequency | Factor | Standard |
| Discrete | Certain | Various | Bands in Various | | Deviation of |
| Difference of | Frequency | Frequency | Time Intervals | | Graph's |
| time series | Band to the | Bands | | | Degree |
| | Total | | | | |
| | Power | | | | |
| Kurtosis of | | Fisher | Mean Power of | | |
| Original and | | Information | Various Frequency | | |
| Discrete | | | Bands in Various | | |
| Difference of | | | Time Intervals | | |
| time series | | | | | |

In an example embodiment, the plurality of statistical indices mentioned includes, but is not limited to the frequency domain indices: The frequency domain indices involve transforming the first time series data set using techniques like Fourier Transform to study the periodic components of the first time series data set.

In an example embodiment, the plurality of statistical indices mentioned includes, but is not limited to the non-linear domain indices. The non-linear domain indices are crucial for the first time series data set that exhibits complex dynamics which may not be well-represented by different linear models.

In an example embodiment, the plurality of statistical indices mentioned includes, but is not limited to the time-frequency domain indices. The time-frequency domain indices provide a joint understanding of both time and frequency characteristics simultaneously.

In an example embodiment, the plurality of statistical indices mentioned includes, but is not limited to the shape domain indices. The shape domain indices focus on geometric properties of the time series, capturing behaviour of the overall structure or pattern of the first time series data set.

In an example embodiment, the plurality of statistical indices mentioned includes but is not limited to the graph domain indices. The graph domain indices represent the first time series data set as a graphical representation, with data points illustrated as nodes, and edges capture relationships between the nodes.

At operation 305, the feature determination module 203 may be configured to determine the second set of features, associated with the second time series data set, with respect to the plurality of perspectives.

In an embodiment, after processing the first time series data set, the feature determination module 203 may be configured to repeat the above-discussed procedure for the second time series data set, ensuring that the second set of features is determined across the same plurality of perspectives.

The second time series data set is associated with the target domain thus, representing real-world data collected in real-time, new experimental data, or even simulated data, depending on the use case. In an advantageous aspect, the determination of the second set of features from the second time series data set identifies the statistical properties and patterns that characterize the second time series data set in the same way the first time series data set was analysed. Consequently, the system 101 ensures that both the second time series data set and the first time series data set are compared based on an equal and comprehensive set of attributes.

At operation 307, the divergence determination module 205 may be configured to standardize or normalize varying scales of the first set of features and the second set of features with respect to at least one of range normalization, interquartile range normalization, and standard deviation normalization of the varying scales. In an advantageous aspect, standardization or normalization ensures that the first set of features and the second set of features extracted from the two datasets are expressed on a comparable scale, allowing for accurate calculation of divergence values between the features.

In an embodiment, the first time series data set and the second time series data set may have different characteristics. For instance, features like amplitude, frequency, or statistical measures may be measured on different scales. Additionally, the features may also vary on different scales within the first time series data set. Now, if such differences in characteristics are not considered, the determination of the plurality of divergence values in subsequent steps may be misleading, as it would interpret the differences in characteristics as a fundamental difference in the nature of the first time series data set and the second time series data set. However, the differences in characteristics may simply be due to measurement differences. Thus, normalising ensures that the first set of features and the second set of features are brought onto a common scale, making them directly comparable.

In an example embodiment, the range normalization technique corresponds to rescaling the first set of features and the second set of features so that they fall within a common range, typically between 0 and 1. The range normalization technique is useful when there are large differences in the units or magnitude of the first set of features and the second set of features.

In an example embodiment, the interquartile range (IQR) normalization technique corresponds to a measure of statistical dispersion, representing the range within which the central 50% of the data lies. The IQR normalization involves scaling the first set of features and the second set of features based on the IQR, which is particularly useful when the data contains outliers.

In an example embodiment, the standard deviation normalization technique corresponds to adjusting the first set of features and the second set of features so that they are expressed in terms of standard deviations away from their mean.

Thus, in an advantageous aspect, the standardization or normalization yields accurate results. In an example scenario, a feature measured in Fahrenheit in the first time series data set may be measured in Celsius in the second time series data set. Accordingly, without normalizing these two features to a common scale, the divergence determination module 205 would incorrectly interpret the scale difference as a domain gap, when in reality, it is simply a difference in units.

At operation 309, the divergence determination module 205 may be configured to determine the plurality of divergence values associated with the distribution of the first set of features and the second set of features, between the first time series data and the second time series data across the plurality of perspectives using a predetermined divergence metric. In an advantageous aspect, determining the plurality of divergence values is crucial because it quantifies the similarity or difference between the first time series data set and the second time series data set thus, offering insights into the domain gap between the source and target domains. Further, the divergence values may be obtained with respect to the distributions for each feature in the first set of features and the second set of features respectively.

In an embodiment, the plurality of divergence values is calculated across the plurality of perspectives, which represent the plurality of statistical indices such as the time domain, the frequency domain, and the non-linear domain. Thus, based on determining the plurality of divergence values across various perspectives, the divergence determination module 205 captures the difference between the first time series data set and the second time series data set from multiple approaches, thereby ensuring a comprehensive comparison. For instance, in the time domain, the plurality of divergence values may refer to the average, variance, or trend difference between the first time series data set and the second time series data. Similarly, in the non-linear domain, the plurality of divergence values may refer to difference in magnitude of irregularity in the first time series data set and the second time series data set.

In a non-limiting example, the plurality of divergence values may be determined using the predetermined divergence metric such as a Wasserstein distance. In the non-limiting example, the Wasserstein distance refers to a measure of the difference between two probability distributions. The Wasserstein distance calculates a cost of transforming one distribution into another. In the example of time series data, the Wasserstein distance metric measures the effort required to morph the distribution of the first set of features from the first time series data set into the distribution of the second set of features from the second time series data set. In an advantageous aspect, the Wasserstein distance considers the overall shape and distribution of the data, making it a more meaningful measure of divergence when comparing complex time series features.

In the non-limiting example, the Wasserstein distance metric may be used as a loss function in the AI model 109. Thereby, the Wasserstein distance metric guides the optimization process by minimizing the difference between the predicted and actual distributions during the training of the AI model 109. In an advantageous aspect, the Wasserstein distance metric is useful when working with time series data and in transfer learning with an objective of aligning the behaviour of a model trained on the first time series data set (source domain) with the characteristics of the second time series data set (target domain).

In an embodiment, thus, the plurality of divergence values determined provides a quantitative measure of the difference between the source data set and the target data set across different statistical perspectives. For instance, if the divergence value for the time domain is high, it suggests that the two datasets differ significantly in terms of their time-related characteristics e.g., trends or variations over time. Further, if the divergence value for the frequency domain is low, it indicates that the two datasets are similar in their frequency components e.g., having similar periodic behaviour. In an advantageous aspect, the plurality of divergence values is crucial because they directly feed into the further steps where the system 101 aggregates the plurality of divergence values to determine the domain gap metric. The domain gap metric represents the overall difference between the source data set and target data set, thereby providing insights into adjustments to be made by the system 101 to bridge the gap.

At operation 311, the domain gap determination module 207 may be configured to determine the one or more domain gap metrics by combining the plurality of divergence values in a predetermined manner.

The plurality of divergence values, determined across various perspectives such as time, frequency, and shape, represents the difference between the first set of features and the second set of features. Thus, based on combining the plurality of divergence values in the predetermined manner, the domain gap determination module 207 determines or generates the one or more domain gap metrics that quantify the overall difference between the first time series data set and the second time series data set. The one or more domain gap metrics may be used to inform decisions related to model development, transfer learning, and data selection.

In an embodiment, one or more domain gap metrics provide a single or multiple numerical values in a matrix form to summarize the difference between the source data set and the target data set. Consequently, the one or more domain gap metrics aggregate each of the plurality of divergence values determined for each feature of the first set of features and the second set of features. Thereby, the one or more domain gap metrics offer an assessment of the divergence of the two datasets.

Thus, the information on the assessment of the divergence of the two datasets is essential for various tasks such as transfer learning, with an objective to determine the generalization of the AI model 109 which is trained on the source dataset (the first time series data set) to the target dataset (the second time series data set).

In an embodiment, the plurality of divergence values may be combined in different ways to determine the one or more domain gap metrics or variants, each of which may offer different insights into the nature of the domain gap.

In an example embodiment, the one or more domain gap metrics may be an arithmetic mean gap metric. The arithmetic mean gap metric may be determined based on the mean of the plurality of divergence values for the first set of features and the second set of features.

In an example embodiment, the one or more domain gap metrics may be an arithmetic mean gap metric with feature ranking. The arithmetic mean gap metric with feature ranking refines the arithmetic mean gap metric by incorporating a ranking system based on the importance of the first set of features and the second set of features. Further, the plurality of divergence values corresponding to the first set of features and the second set of features having a certain predetermined threshold are included in the determination. In an advantageous aspect, the arithmetic mean gap metric with feature ranking allows for a more focused domain gap metric by prioritizing the features that have a significant impact on the source and target dataset's divergence. Further, the arithmetic mean gap metric with feature ranking excludes features that are less relevant or less important in domain transfer.

In an example embodiment, the one or more domain gap metrics may be weighted mean gap metric with or without feature ranking. The weighted mean gap metric includes assigning each of the plurality of divergence values weights based on the importance of the corresponding feature. The importance weight or score refers to the contribution of a feature in distinguishing the source data set and the target data sets. In an advantageous aspect, the weighted mean gap metric provides an assessment of the domain gap by considering for the relative significance for each of the first set of features and the second set of features. For instance, features that are more important to the AI model 109 or the domain are assigned more weight in the determination of the one or more domain gap metrics, thereby offering a deeper understanding of the gap between the two datasets. Advantageously, the weighted mean gap metric helps prioritize areas for further optimization or adjustments during the AI model 109 training or transfer learning.

Further, in an embodiment, the one or more domain gap metrics is an explainable domain gap metrics. The explainable domain gap metrics refer to gap metrics that provide insights into the underlying differences between the source data set and the target data set by breaking down the divergence across specific features or aspects of the data. The explanation may be done by analysing statistical features such as time-domain, frequency-domain, shape-domain, and graph domain.

Furthermore, in the explainable domain gap metrics the plurality of divergence values may be determined for specific, interpretable features such as time, frequency, or shape characteristics. Advantageously, this allows the user to see which features contribute most to the domain gap. Thus, the explainability corresponds to the feature that users understand a reason for the domain gap based on analysing specific features and corresponding divergence values, rather than just observing the existence of a difference. Advantageously, the explainable domain gap metrics create transparency that leads to more informed decision-making in the development of the AI model 109.

In an example scenario where the first time series data set is synthetic data generated by the AI model 109, and the second data set may be the real-time data. The system 101 determines the domain gap metrics by comparing the divergence values between these two datasets, which helps to identify the difference in distribution between synthetic and real-world data. The determined domain gap metrics are then used to fine-tune the AI model 109, ensuring it performs better on the real-time data. The example scenario applies to AI models that are initially trained on synthetic data but need to be optimized for real-world applications, for instance, autonomous vehicles or financial forecasting.

In an example scenario, where the first time series data set consists of multiple distinct sets of data from a particular category, and the second time series data set is another set from the same category. The domain gap metrics are used to compare the divergence values between these datasets, allowing the system 101 to identify the optimal subset from the distinct sets that best match the target data set. Thus, this approach improves the AI model 109 performance by selecting the most suitable data for training and is useful in applications like health diagnostics or climate modelling, with one or more than one dataset.

In an example scenario involving synthetic data from a simulator is referred to as the first time series data set and the real-time data as the second time series data set. The domain gap metrics measure the divergence between the output of the simulator and the real-world data, thereby guiding the optimization of the simulator to better match real conditions. The example scenario applies to fields like robotics or flight simulations, intending to adjust the simulator's parameters to improve accuracy in real-world operations.

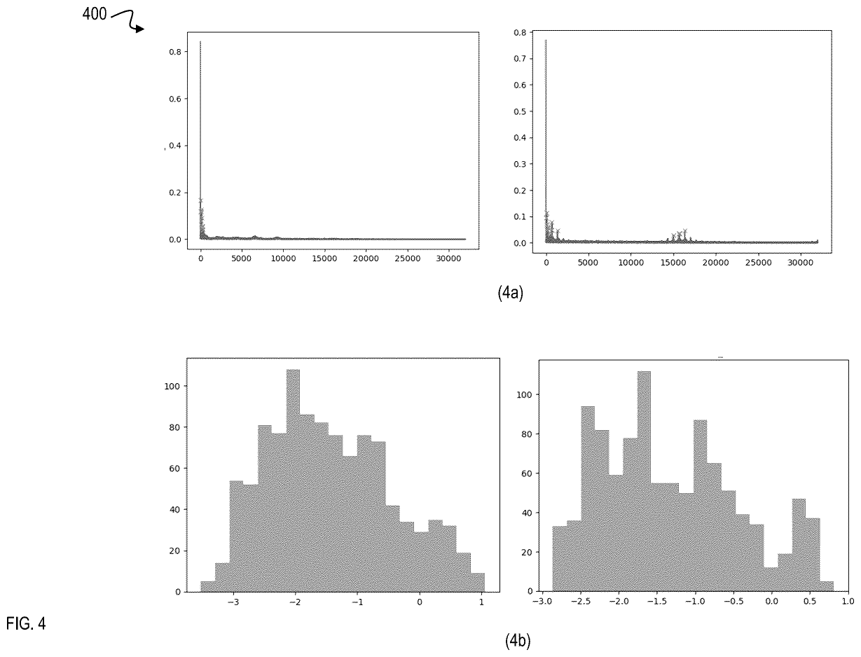

FIGS. 4a and 4b illustrates an exemplary representation 400 of a frequency spectrum for the one or more domain gap metrics generated by the system for efficient model development, according to an embodiment of the present invention.

In an embodiment, the system 101 analyses both overall and feature-level gap metrics, enabling improved model tuning, data preprocessing, and augmentation. For example, the gap metric analysis on the frequency domain features of two-time series, whose spectrums are depicted in the FIG. 4, guides critical steps in optimizing model performance, ensuring more accurate data processing and enhancing the overall development process.

For example, as depicted in FIG. 4a represents frequency spectrum of a single data sample in a time series dataset (source or target) from which frequency features are calculated. Upon calculating a certain feature (in present example, a frequency feature) from data samples in the time series dataset leads to a distribution as shown in the FIG. 4b. Thereafter, the plurality of divergence values for each feature may be determined using the predetermined divergence metric such as a Wasserstein distance based on the distribution depicted in FIG. 4b.

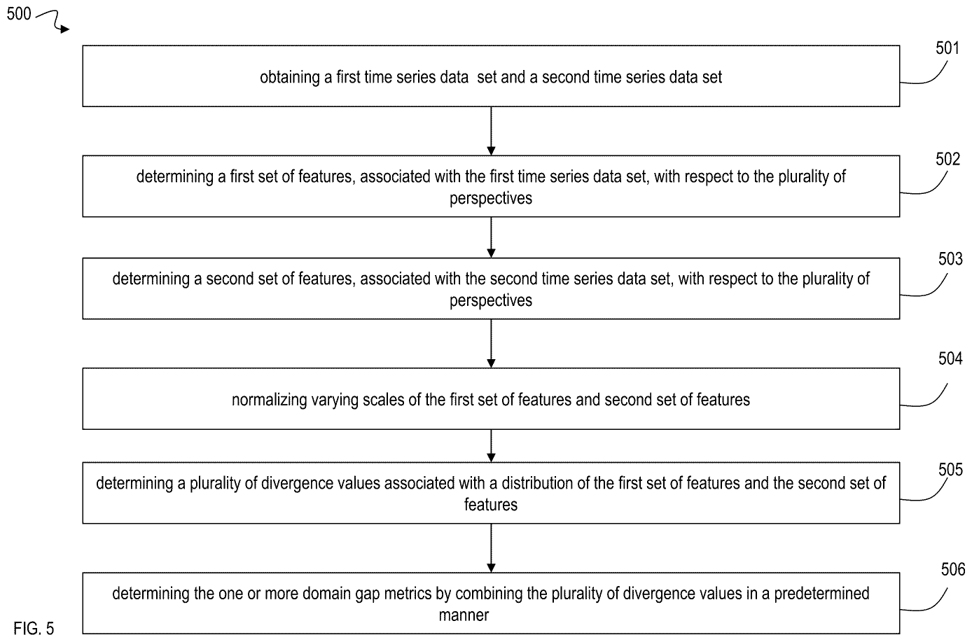

FIG. 5 illustrates a flowchart depicting a method 500 for determining the one or more domain gap metrics using the system 101, according to an embodiment of the present invention. The method 500 may be performed by the system 101, in particular, the processor 105 of the system 101. For the sake of brevity, steps explained in FIG. 1-FIG. 4 are not repeated in the following FIG. 5.

At step 501, the method 500 may include obtaining the first time series data set and the second time series data set.

At step 502, the method 500 may include determining the first set of features, associated with the first time series data set, with respect to the plurality of perspectives.

At step 503, the method 500 may include determining the second set of features, associated with the second time series data set, with respect to the plurality of perspectives.

At step 504, the method 500 may include normalizing varying scales of the first set of features and the second set of features.

At step 505, the method 500 may include determining the plurality of divergence values associated with the distribution of the first set of features and the second set of features, between the first time series data and the second time series data across the plurality of perspectives using the predetermined divergence metric.

At step 506, the method 500 may include determining the one or more domain gap metrics by combining the plurality of divergence values in the predetermined manner.

The above invention may have the following advantages:
The present invention provides explainable domain gap metrics using statistical features for better model interpretation.
The present invention provides enhanced data preprocessing and augmentation based on feature-level divergence analysis.
The present invention provides optimized transfer learning by predicting performance across datasets before extensive experiments.
The present invention enables efficient model fine-tuning by quantifying domain differences between synthetic and real data.
The present invention facilitates the selection of optimal training data subsets through feature divergence comparison.
The present invention improves simulator accuracy by measuring divergence between simulated and real-time data.
The present invention supports multi-domain adaptation with customizable gap metric calculations.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for determining one or more domain gap metrics for time series data, the method comprising:
obtaining a first time series data set and a second time series data set;
determining a first set of features, associated with the first time series data set, with respect to a plurality of perspectives;
determining a second set of features, associated with the second time series data set, with respect to the plurality of perspectives;
determining a plurality of divergence values associated with a distribution of the first set of features and the second set of features, between the first time series data and the second time series data across the plurality of perspectives using a predetermined divergence metric; and
determining the one or more domain gap metrics by combining the plurality of divergence values in a predetermined manner.

2. The method as claimed in claim 1, wherein the plurality of perspectives correspond to a plurality of statistical indices, wherein the plurality of statistical indices includes one or more of time domain indices, frequency domain indices, non-linear domain indices, time-frequency domain indices, shape domain indices, and graph domain indices.

3. The method as claimed in claim 1, wherein prior to determining the plurality of divergence values, the method comprises:
normalizing varying scales of the first set of features and second set of features with respect to at least one of range, interquartile range, and standard deviation of the varying scales.

4. The method as claimed in claim 1, wherein the one or more domain gap metrics include at least one of an arithmetic mean gap metric, arithmetic mean gap metric with feature ranking, weighted mean gap metric with feature ranking, and weighted mean gap metric without feature ranking.

5. The method as claimed in claim 1, wherein:
the first time series data set corresponds to a set of synthetic data generated using an artificial intelligence (AI) model;
the second time series data set corresponds to a set of real-time data; and
determining the one or more domain gap metrics comprises:
determining one or more domain gap metrics associated with the plurality of divergence values between the set of synthetic data generated using the artificial intelligence (AI) model and the set of real-time data such that the AI model is fine tuned.

6. The method as claimed in claim 1, wherein
the first time series data set corresponds to a plurality of distinct sets of a data of a first category;
the second time series data set corresponds to another set of data of the first category; and
determining the one or more domain gap metrics comprises:
determining one or more domain gap metrics associated with the plurality of divergence values between the plurality of distinct sets of a data of a first category and the another set of data of the first category such that at least one optimal set of data is selected from the plurality of distinct sets of a data of a first category.

7. The method as claimed in claim 1, wherein
the first time series data set corresponds to a set of synthetic data generated using a simulator;
the second time series data set corresponds to a set of real-time data; and
determining the one or more domain gap metrics comprises:
determining one or more domain gap metrics associated with the plurality of divergence values between the set of synthetic data generated using the simulator and the set of real-time data such that the simulator is optimized.

8. A system for determining one or more domain gap metrics for time series data, the system comprises:
a memory;
a processor associated with the memory, the processor being configured to:
obtain a first time series data set and a second time series data set;
determine a first set of features, associated with the first time series data set, with respect to a plurality of perspectives;
determine a second set of features, associated with the second time series data set, with respect to the plurality of perspectives;
determine a plurality of divergence values associated with a distribution of the first set of features and the second set of features, between the first time series data and the second time series data across the plurality of perspectives using a predetermined divergence metric; and
determine the one or more domain gap metrics by combining the plurality of divergence values in a predetermined manner.

9. The system as claimed in claim 8, wherein the plurality of perspectives correspond to a plurality of statistical indices, wherein the plurality of statistical indices includes one or more of time domain indices, frequency domain indices, non-linear domain indices, time-frequency domain indices, shape domain indices, and graph domain indices.

10. The system as claimed in claim 8, wherein prior to determining the plurality of divergence values, the processor is configured to:
normalize varying scales of the first set of features and second set of features with respect to at least one of range, interquartile range, and standard deviation of the varying scales.

11. The system as claimed in claim 8, wherein the one or more domain gap metrics include at least one of an arithmetic mean gap metric, arithmetic mean gap metric with feature ranking, weighted mean gap metric with feature ranking, and weighted mean gap metric without feature ranking.

12. The system as claimed in claim 8, wherein:
the first time series data set corresponds to a set of synthetic data generated using an artificial intelligence (AI) model;
the second time series data set corresponds to a set of real-time data; and
for determining the one or more domain gap metrics, the processor is configured to:
determine one or more domain gap metrics associated with the plurality of divergence values between the set of synthetic data generated using the artificial intelligence (AI) model and the set of real-time data such that the AI model is fine tuned.

13. The system as claimed in claim 8, wherein
the first time series data set corresponds to a plurality of distinct sets of a data of a first category;
the second time series data set corresponds to another set of data of the first category; and
for determining the one or more domain gap metrics, the processor is configured to:
determine one or more domain gap metrics associated with the plurality of divergence values between the plurality of distinct sets of a data of a first category and the another set of data of the first category such that at least one optimal set of data is selected from the plurality of distinct sets of a data of a first category.

14. The system as claimed in claim 8, wherein
the first time series data set corresponds to a set of synthetic data generated using a simulator;
the second time series data set corresponds to a set of real-time data; and
for determining the one or more domain gap metrics, the processor is configured to:
determine one or more domain gap metrics associated with the plurality of divergence values between the set of synthetic data generated using the simulator and the set of real-time data such that the simulator is optimized.
